(19) United States
(12) Patent Application Publication
(10) Pub. No.: US 2024/0404243 A1
(43) Pub. Date: Dec. 5, 2024

(54) EFFICIENT AUGMENTATION FOR MULTIMODAL MACHINE LEARNING

(71) Applicant: ADOBE INC., SAN JOSE, CA (US)

(72) Inventors: Handong Zhao, Cupertino, CA (US); Yue Bai, Malden, MA (US); Zhe Lin, Clyde Hill, WA (US); Ajinkya Gorakhnath Kale, San Jose, CA (US); Jiuxiang Gu, Baltimore, MD (US); Tong Yu, Fremont, CA (US); Sungchul Kim, San Jose, CA (US)

(21) Appl. No.: 18/328,950

(22) Filed: Jun. 5, 2023

(51) Int. Cl. G06V 10/75; G06F 16/332; G06V 10/774

(52) U.S. Cl. CPC G06V 10/751; G06F 16/3329; G06V 10/774

(57) ABSTRACT

Systems and methods for multimodal machine learning are provided. According to one aspect, a method for multimodal machine learning includes obtaining a prompt; encoding the prompt using a multimodal encoder to obtain a prompt embedding, wherein the encoding comprises generating a plurality of multi-head attention (MHA) outputs corresponding to a plurality of different scales, respectively, and combining the plurality of MHA outputs using a multi-scale aggregator; and generating a response to the prompt based on the prompt embedding.

### BACKGROUND

The following relates generally to machine learning, and more specifically to multimodal machine learning. Machine learning algorithms build a model based on sample data, known as training data, to make predictions or decisions without being explicitly programmed to do so.

Machine learning systems can be trained to be used for multiple modalities. For example, a machine learning system can be trained to generate an output in a first modality (such as an image modality) by making a prediction for the output based on an input in the first modality or in a second modality (such as a text modality). However, it is expensive and time-consuming to re-train a conventional machine learning system to more effectively perform multimodal tasks, and existing training datasets that are suitable for training the conventional machine learning system may include noisy data, which can negatively impact a performance of the conventional machine learning system by teaching the conventional machine learning system to generate an incorrect output for an input. There is therefore a need in the art for a machine learning system having increased performance.

### SUMMARY

An embodiment of the present disclosure provides a machine learning system that accepts an input, generates multiple outputs at multiple scales based on the input using a multimodal encoder, generates an aggregated output based on the multiple outputs using the multimodal encoder, and generates a response based on the aggregated output. By generating the multiple outputs and aggregated output using the multimodal encoder, the machine learning system is able to effectively increase a capacity of the multimodal encoder, thereby generating a more accurate response for the input than a conventional machine learning system employing a conventional multimodal encoder can provide.

A method, apparatus, non-transitory computer readable medium, and system for multimodal machine learning are described. One or more aspects of the method, apparatus, non-transitory computer readable medium, and system include obtaining a prompt; encoding the prompt using a multimodal encoder to obtain a prompt embedding, wherein the encoding comprises generating a plurality of multi-head attention (MHA) outputs corresponding to a plurality of different scales, respectively, and combining the plurality of MHA outputs using a multi-scale aggregator; and generating a response to the prompt based on the prompt embedding.

A method, apparatus, non-transitory computer readable medium, and system for multimodal machine learning are described. One or more aspects of the method, apparatus, non-transitory computer readable medium, and system include obtaining training data comprising an image and text describing the image; encoding the text using a multimodal encoder to obtain a predicted text embedding, wherein encoding the text comprises generating a plurality of multi-head attention (MHA) text outputs corresponding to a plurality of different text scales, respectively, and combining the plurality of MHA text outputs using a text multi-scale aggregator; encoding the image using the multimodal encoder to obtain a predicted image embedding, wherein encoding the image comprises generating a plurality of MHA image outputs corresponding to a plurality of different image scales, respectively, and combining the plurality of MHA image outputs using an image multi-scale aggregator; and training the multimodal encoder based on the predicted image embedding and the predicted text embedding.

An apparatus and system for multimodal machine learning are described. One or more aspects of the apparatus and system include at least one processor; at least one memory storing instructions executable by the processor; and a multimodal encoder comprising parameters stored in the at least one memory, wherein the multimodal encoder comprises a multi-scale aggregator and is configured to encode a prompt to obtain a prompt embedding by generating a plurality of multi-head attention (MHA) outputs corresponding to a plurality of different scales, respectively, and combining the plurality of MHA outputs using the multi-scale aggregator.

### BRIEF DESCRIPTION OF THE DRAWINGS

FIG. 1 shows an example of a machine learning system according to aspects of the present disclosure.

FIG. 2 shows an example of a machine learning apparatus according to aspects of the present disclosure.

FIG. 3 shows an example of a multimodal encoder according to aspects of the present disclosure.

FIG. 4 shows an example of data flow in a machine learning apparatus according to aspects of the present disclosure.

FIG. 5 shows an example of a method for cross-modal retrieval according to aspects of the present disclosure.

FIG. 6 shows an example of a method for generating a response to a prompt according to aspects of the present disclosure.

FIG. 7 shows an example of noisy paired samples according to aspects of the present disclosure.

FIG. 8 shows an example of a multi-scale image attention process according to aspects of the present disclosure.

FIG. 9 shows an example of a multi-scale text attention process according to aspects of the present disclosure.

FIG. 10 shows an example of cross-modal retrieval results according to aspects of the present disclosure.

FIG. 11 shows an example of a method for training a multimodal encoder according to aspects of the present disclosure.

### DETAILED DESCRIPTION

The following relates generally to machine learning, and more specifically to multimodal machine learning. Machine learning algorithms build a model based on sample data, known as training data, to make predictions or decisions without being explicitly programmed to do so.

Machine learning systems can be trained to be used for multiple modalities. For example, a machine learning system can be trained to generate an output in a first modality (such as an image modality) by making a prediction for the output based on an input in the first modality or in a second modality (such as a text modality). However, it is expensive and time-consuming to re-train a conventional machine learning system to more effectively perform multimodal tasks, and existing training datasets that are suitable for training the conventional machine learning system may include noisy data, which can negatively impact a performance of the conventional machine learning system by teaching the conventional machine learning system to generate an incorrect output for an input.

An embodiment of the present disclosure provides a machine learning system that accepts an input, generates multiple outputs at multiple scales based on the input using a multimodal encoder, generates an aggregated output based on the multiple outputs using the multimodal encoder according to an ensemble strategy, and generates a response based on the aggregated output. By generating the multiple outputs and aggregated output using the multimodal encoder, the machine learning system is able to effectively increase a capacity of the multimodal encoder, thereby generating a response that more closely matches the input than a conventional machine learning system employing a conventional multimodal encoder can provide.

According to some aspects, the multimodal encoder includes a pre-trained encoder and the multi-scale aggregator. In some cases, the pre-trained encoder is used to generate the multiple outputs. In some cases, by aggregating the multiple outputs using the multi-scale aggregator, the machine learning system takes advantage of the processing power of the pre-trained encoder to create initial outputs while also increasing the performance of the pre-trained encoder by combining the initial outputs. In some cases, the machine learning system accordingly provides a multimodal encoder having an increased performance over conventional multimodal encoders that employ a similar pre-trained encoder, as the combination of the multiple outputs compensates for errors made by the pre-trained encoder as a result of being trained on noisy training data.

In some cases, the machine learning system employs the multiple outputs and the aggregated output according to an ensemble strategy of projecting the aggregated output to an original dimensionality of an original feature vector output by the multimodal encoder. In some cases, the ensemble strategy is an efficient augmentation that enhances the capacity of the multimodal encoder with almost negligible additional cost.

According to some aspects, the machine learning system includes an adapter in the multimodal encoder. In some cases, the adapter is a structure that allows for efficient downstream fine-tuning of machine learning models by relaxing learnable parameters, which is friendly to a small amount of downstream data. In some cases, the machine learning system trains the multimodal encoder by freezing a pre-trained encoder included in the multimodal encoder and updating the parameters of the adapter. In some cases, the adapter therefore allows the multimodal encoder to be trained to generate outputs using the multi-scale aggregator without retraining all of the parameters of the pre-trained encoder, which is a costly and time-consuming process.

An embodiment of the present disclosure is used in a cross-modal retrieval context. For example, a user provides a text prompt to the machine learning system to retrieve an image that includes a depiction of content included in the text prompt. The multimodal retrieval system generates an embedding of the text prompt using a multimodal encoder based on an aggregation of multiple attention scales applied to the text prompt. By generating the embedding based on the aggregation, a processing capacity of the multimodal encoder is effectively increased, thereby providing for an increased amount of semantic information included in the embedding.

The increased semantic information allows the machine learning system to match the embedding to an embedding of the image at a greater level of detail than conventional machine learning systems. The machine learning system determines that the embedding of the text prompt matches the image embedding, and retrieves the image corresponding to the image embedding based on the determination. The machine learning system generates a response including the image and provides the response to the user.

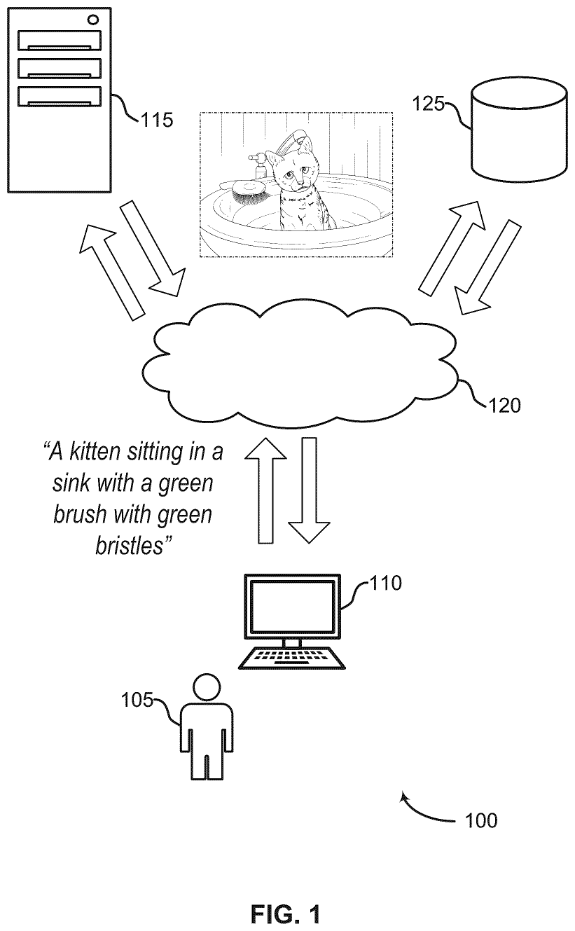

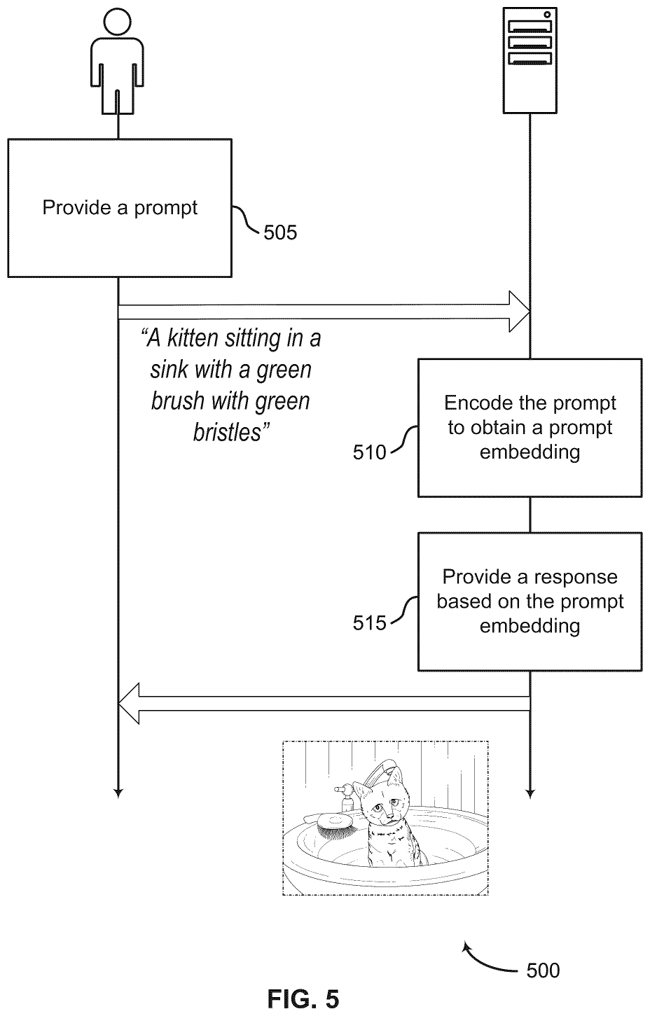

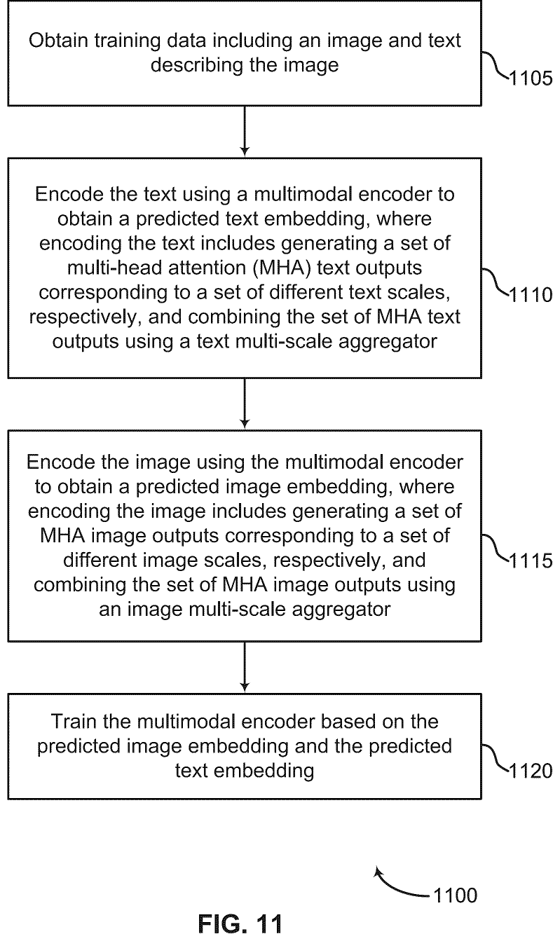

Example applications of the present disclosure in the cross-modal retrieval context are provided with reference to FIGS. 1 and 5. Details regarding the architecture of the machine learning system are provided with reference to FIGS. 1-4. Details regarding a process for multimodal machine learning are provided with reference to FIGS. 5-10. Details regarding a process for training the machine learning model are provided with reference to FIG. 11.

### Machine Learning System

A system and an apparatus for multimodal machine learning is described with reference to FIGS. 1-4. One or more aspects of the system and the apparatus include at least one processor; at least one memory storing instructions executable by the processor; and a multimodal encoder comprising parameters stored in the at least one memory, wherein the multimodal encoder comprises a multi-scale aggregator and is configured to encode a prompt to obtain a prompt embedding by generating a plurality of multi-head attention (MHA) outputs corresponding to a plurality of different scales, respectively, and combining the plurality of MHA outputs using the multi-scale aggregator.

Some examples of the system and the apparatus further include a training component configured to train the multimodal encoder. In some aspects, the multimodal encoder comprises an image multi-scale aggregator in an image encoder and a text multi-scale aggregator in a text encoder. In some aspects, the multimodal encoder comprises an adapter following the multi-scale aggregator. In some aspects, the multimodal encoder is pretrained without the multi-scale aggregator and fine-tuned with the multi-scale aggregator. Some examples of the system and the apparatus further include a response component configured to generate a response to the prompt based on the prompt embedding.

FIG. 1 shows an example of a machine learning system 100 according to aspects of the present disclosure. The example shown includes user 105, user device 110, machine learning apparatus 115, cloud 120, and database 125.

Referring to FIG. 1, an embodiment of the present disclosure is used in a cross-modal retrieval context. For example, user 105 provides a text prompt (e.g., “A kitten sitting in a sink with a green brush with green bristles”) to machine learning apparatus 115 via user device 110 and cloud 120. In some cases, machine learning apparatus 115 provides a user interface (e.g., a graphical user interface) on user device 110 for receiving the text prompt and transmitting the text prompt to machine learning apparatus 115.

Machine learning apparatus 115 generates an embedding for the text prompt using a machine learning model. Machine learning apparatus 115 then retrieves an image embedding from database 125 and determines that the embedding for the text prompt matches the image embedding. Based on the determination, machine learning apparatus 115 retrieves an image that corresponds to the image embedding from database 125 and generates a response including the image. Machine learning apparatus 115 provides the response including the image to user 105 via the user interface displayed on user device 110. Referring to FIG. 1, the image depicts content described by the text prompt.

According to some aspects, user device 110 is a personal computer, laptop computer, mainframe computer, palmtop computer, personal assistant, mobile device, or any other suitable processing apparatus. In some examples, user device 110 includes software that can transmit, receive, and/or display information that can be transmitted in visual and/or auditory form, including but not limited to text, images, video, audio, etc.

According to some aspects, a user interface enables user 105 to interact with user device 110. In some embodiments, the user interface may include an audio device, such as an external speaker system, an external display device such as a display screen, or an input device (e.g., a remote-control device interfaced with the user interface directly or through an I/O controller module). In some cases, the user interface may be a graphical user interface. In some cases, the graphical user interface is provided by machine learning apparatus 115.

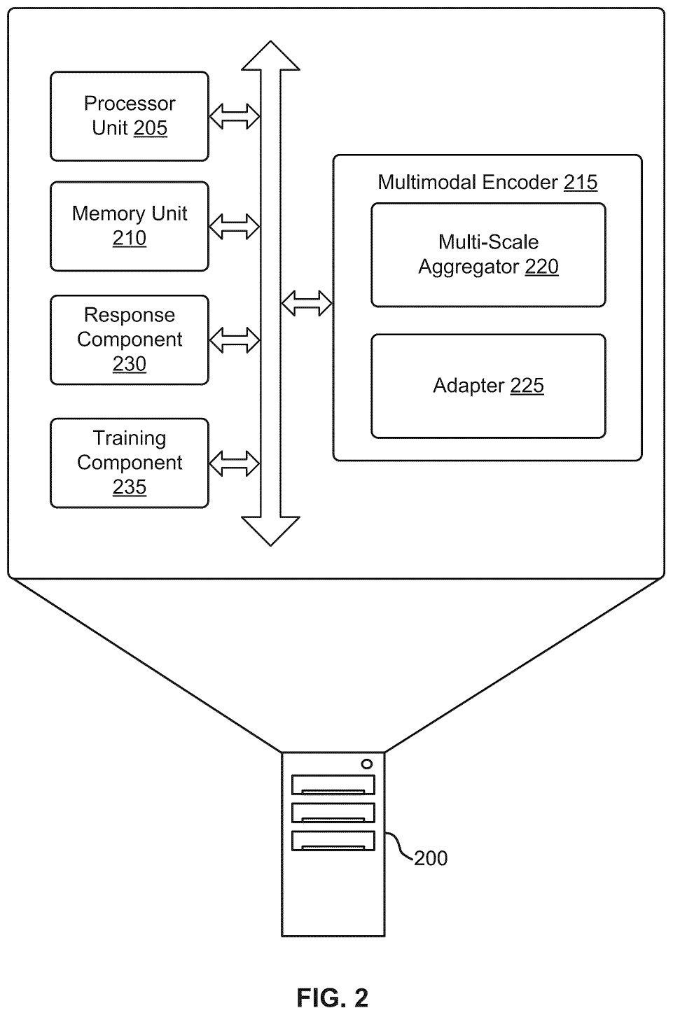

According to some aspects, machine learning apparatus 115 includes a computer implemented network. In some embodiments, the computer implemented network includes a machine learning model (such as the machine learning model described with reference to FIGS. 2-4). Additionally, in some embodiments, machine learning apparatus 115 communicates with user device 110 and database 125 via cloud 120.

In some cases, machine learning apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Machine learning apparatus 115 is an example of, or includes aspects of, the corresponding element described with reference to FIGS. 2. Further detail regarding the architecture of machine learning apparatus 115 is provided with reference to FIGS. 2-4. Further detail regarding a process for cross-modal retrieval is provided with reference to FIGS. 5-10. Further detail regarding a process for training the machine learning model is provided with reference to FIGS. 11.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if it has a direct or close connection to a user. In some cases, cloud 120 is limited to a single organization. In other examples, cloud 120 is available to many organizations. In one example, cloud 120 includes a multi-layer communications network comprising multiple edge routers and core routers. In another example, cloud 120 is based on a local collection of switches in a single physical location. According to some aspects, cloud 120 provides communications between user device 110, machine learning apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to machine learning apparatus 115 and communicates with machine learning apparatus 115 via cloud 120. According to some aspects, database 125 is included in machine learning apparatus 115.

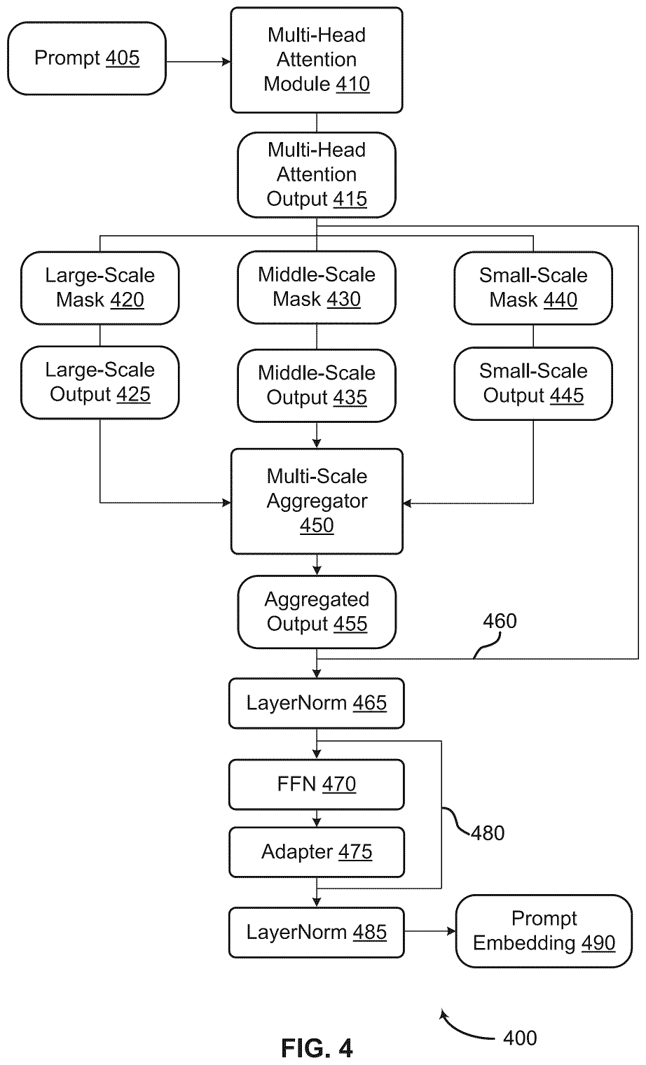

FIG. 2 shows an example of a machine learning apparatus 200 according to aspects of the present disclosure. Machine learning apparatus 200 is an example of, or includes aspects of, the corresponding element described with reference to FIGS. 1 and 4. In one aspect, machine learning apparatus 200 includes processor unit 205, memory unit 210, multimodal encoder 215, response component 230, and training component 235.

Processor unit 205 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof. In some cases, processor unit 205 is configured to operate a memory array using a memory controller. In other cases, a memory controller is integrated into processor unit 205. In some cases, processor unit 205 is configured to execute computer-readable instructions stored in memory unit 210 to perform various functions. In some aspects, processor unit 205 includes special purpose components for modem processing, baseband processing, digital signal processing, or transmission processing.

Memory unit 210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor of processor unit 205 to perform various functions described herein. In some cases, memory unit 210 includes a basic input/output system (BIOS) that controls basic hardware or software operations, such as an interaction with peripheral components or devices. In some cases, memory unit 210 includes a memory controller that operates memory cells of memory unit 210. For example, the memory controller may include a row decoder, column decoder, or both. In some cases, memory cells within memory unit 210 store information in the form of a logical state. In some cases, memory unit 210 stores parameters of multimodal encoder 215.

According to some aspects, machine learning apparatus 200 obtains a prompt. For example, in some cases, one or more processors of processor unit 205 implement an instruction stored in memory of memory unit 210 to obtain the prompt. In some aspects, the prompt includes a text prompt and the prompt embedding includes a text embedding in a multimodal embedding space. In some aspects, the prompt includes an image prompt and the prompt embedding includes an image embedding in a multimodal embedding space.

According to some aspects, multimodal encoder 215 comprises one or more encoder networks. In some cases, an encoder network of the one or more encoder networks comprises one or more artificial neural networks (ANNs). An ANN is a hardware or a software component that includes a number of connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms, such as selecting the max from the inputs as the output, or any other suitable algorithm for activating the node. Each node and edge are associated with one or more node weights that determine how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the neural network. Hidden representations are machine-readable data representations of an input that are learned from a neural network's hidden layers and are produced by the output layer. As the neural network's understanding of the input improves as it is trained, the hidden representation is progressively differentiated from earlier iterations.

During a training process of an ANN, the node weights are adjusted to improve the accuracy of the result (i.e., by minimizing a loss which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

According to some aspects, multimodal encoder 215 encodes the prompt to obtain a prompt embedding, where the encoding includes generating a set of multi-head attention (MHA) outputs corresponding to a set of different scales, respectively, and combining the set of MHA outputs using a multi-scale aggregator 220.

In the machine learning field, an attention mechanism is a method of placing differing levels of importance on different elements of an input. Calculating attention may involve three basic steps. First, a similarity between query and key vectors obtained from the input is computed to generate attention weights. Similarity functions used for this process can include dot product, splice, detector, and the like. Next, a softmax function is used to normalize the attention weights. Finally, the attention weights are weighed together with their corresponding values. In some cases, the attention mechanism uses parameters called a query, a key, and a value. The term “self-attention” refers to a machine learning process in which representations of the input interact with each other to determine attention weights for the input. Self-attention can be distinguished from other attention models because the attention weights are determined at least in part by the input itself.

In some cases, multimodal encoder 215 comprises one or more transformers. In some cases, a transformer is a deep learning ANN that adopts a mechanism of self-attention by differentially weighting a significance of each part of an input to the transformer (including in some cases a recursive output of the transformer). In some cases, a transformer processes sequential input data, such as natural language or a sequence of token embeddings. In some cases, the self-attention mechanism provides context for any position in the input sequence, thereby allowing for increased parallelization and reduced training time. For example, if the input data is a natural language sentence, the transformer might not process one word at a time.

In some cases, a transformer transforms one sequence into another sequence using an encoder and a decoder. The encoder and the decoder can include modules that can be stacked on top of each other multiple times. In some cases, the modules comprise multi-head attention (MHA) and feed-forward layers (or networks, or modules). An MHA module is an ANN for an attention process that runs through an attention mechanism several times in parallel. The MHA module produces independent attention outputs that are then concatenated and linearly transformed into an expected dimension. Multiple attention heads allow for attending to different parts of a sequence differently (e.g. longer-term dependencies versus shorter-term dependencies).

In some examples, a transformer uses a self-attention mechanism to iteratively determine the importance of parts of the input sequence. In some cases, the attention mechanism involves a query, keys, and values denoted by Q, K, and V, respectively. In some cases, Q represents a matrix that contains the query (e.g., a vector representation of one word in the sequence), K represents the keys (e.g., vector representations of all the words in the sequence), and V represents the values (e.g., the vector representations of all the words in the sequence). In some cases, for the multi-head attention modules of the encoder and the decoder, V comprises a same word sequence as Q. However, for an attention module that takes into account the sequences for the encoder and the decoder, V is different from a sequence represented by Q. In some cases, values in V are multiplied and summed with attention weights.

In some cases, a transformer uses the self-attention mechanism to process sequences of data. In some cases, the self-attention mechanism allows the model to weigh the importance of each element in the sequence when making predictions.

In some cases, a transformer includes one or more feed-forward ANNs to process the data after the application of the self-attention mechanism to allow the transformer to make predictions based on the sequence of data. In some cases, a transformer includes layer normalization, which normalizes outputs of the self-attention mechanism and the feed-forward neural network. In some cases, a transformer includes positional encoding to indicate a position of each element in a sequence.

According to some aspects, multimodal encoder 215 comprises the MHA module. In some cases, the MHA module is configured to generate a feature vector based on the prompt. In some cases, the MHA module comprises a set of attention layers. The MHA module is an example of, or includes aspects of, the corresponding element described with reference to FIG. 4.

According to some aspects, multimodal encoder 215 comprises multi-scale aggregator 220. Multi-scale aggregator 220 is an example of, or includes aspects of, the corresponding element described with reference to FIG. 4. According to some aspects, multi-scale aggregator 220 is a pyramid projection layer configured to ensemble the set of MHA outputs by combining the set of MHA outputs to generate an aggregated output. In some cases, multi-scale aggregator 220 is configured to map (e.g., project) the aggregated output to an original dimension of the feature vector generated by the MHA module. In some aspects, multimodal encoder 215 is pretrained without multi-scale aggregator 220 and fine-tuned with multi-scale aggregator 220.

In some cases, multi-scale aggregator 220 comprises a multi-layer perceptron (MLP). In some cases, an MLP is a feed-forward ANN that includes multiple layers of perceptrons. In some cases, a perceptron is a linear classifier. In some cases, a perceptron layer of the multiple layers of perceptrons includes an input layer, one or more hidden layers, and an output layer. In some cases, a node of the perceptron layer includes a nonlinear activation function. In some cases, the MLP is trained using backpropagation (i.e., computing the gradient of the loss function with respect to the parameters).

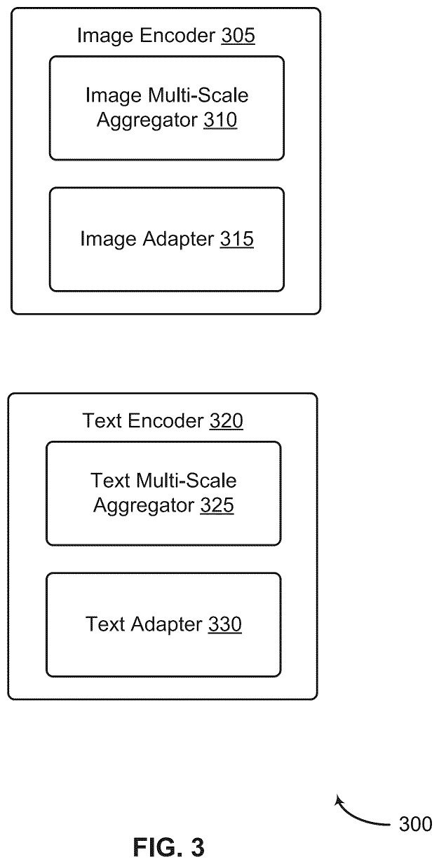

Multi-scale aggregator 220 is an example of, or includes aspects of, the corresponding element described with reference to FIGS. 3-4.

In some examples, multimodal encoder 215 identifies a set of masks corresponding to the set of different scales, respectively, where the set of MHA outputs are based on the set of masks. In some aspects, each of the set of masks indicates neighboring pixels around a central pixel. In some aspects, each of the set of masks indicates neighboring words around a central word. In some cases, one or more processors of processor unit 205 implement an instruction stored in memory of memory unit 210 to identify the set of masks corresponding to the set of different scales, respectively.

In some examples, multimodal encoder 215 processes an output of the multi-scale aggregator 220 (e.g., the aggregated output) using adapter 225, where the prompt embedding is based on an output of adapter 225. In some cases, adapter 225 comprises one or more adapter parameters. In some cases, adapter 225 comprises one or more ANN layers injected into multimodal encoder 215. In some cases, adapter 225 is implemented as a bottleneck adapter. In some aspects, multimodal encoder 215 includes adapter 225 following multi-scale aggregator 220. In some cases, the one or more layers of adapter 225 are randomly initialized. In some cases, adapter 225 is configured to be fine-tuned by training component 235.

In some cases, adapter 225 is configured to project an input feature vector having a first dimension to an intermediate feature vector having a smaller, second dimension and to generate an output feature vector having the first dimension based on the intermediate feature. Accordingly, in some cases, adapter 225 promotes a parameter efficiency of multimodal encoder 215 by allowing parameters of adapter 225 to be fine-tuned such that multimodal encoder 215 can perform a task (instead of fine-tuning an entirety of multimodal encoder 215, or each parameter of multimodal encoder 215). Adapter 225 is an example of, or includes aspects of, the corresponding element described with reference to FIGS. 3-4.

In some aspects, the multimodal encoder 215 includes at least one pre-trained encoder that is fine-tuned based on the multi-scale aggregator 220. In some cases, the pre-trained encoder is an encoder network of the one or more encoder networks of multimodal encoder 215. In some cases, the pre-trained encoder comprises a CLIP (Contrastive Language-Image Pre-Training) model.

In some cases, a CLIP model is one or more ANNs that is pre-trained to efficiently learn visual concepts from natural language supervision. A CLIP model can be instructed in natural language to perform a variety of classification benchmarks without directly optimizing for the benchmarks' performance, in a manner building on “zero-shot” or zero-data learning. A CLIP model can learn from unfiltered, highly varied, and highly noisy data, such as text paired with images found across the Internet, in a similar but more efficient manner to zero-shot learning, thus reducing a need for expensive and large labeled datasets. A CLIP model can be applied to nearly arbitrary visual classification tasks so that the model may predict the likelihood of a text description being paired with a particular image, removing the need for users to design their own classifiers and the need for task-specific training data. For example, a CLIP model can be applied to a new task by inputting names of the task's visual concepts to the model's text encoder. The CLIP model can then output a linear classifier of CLIP's visual representations.

According to some aspects, multimodal encoder 215 encodes a text to obtain a predicted text embedding, where encoding the text includes generating a set of multi-head attention (MHA) text outputs corresponding to a set of different text scales, respectively, and combining the set of MHA text outputs using a text multi-scale aggregator 220.

In some examples, multimodal encoder 215 encodes an image to obtain a predicted image embedding, where encoding the image includes generating a set of MHA image outputs corresponding to a set of different image scales, respectively, and combining the set of MHA image outputs using an image multi-scale aggregator 220.

According to some aspects, multimodal encoder 215 includes an image encoder, multi-scale aggregator 220 is included in the image encoder, and multi-scale aggregator 220 includes an image multi-scale aggregator in an image encoder. In some cases, the image encoder is the pre-trained encoder. In some cases, adapter 225 is implemented in the image encoder.

According to some aspects, multimodal encoder 215 includes a text encoder, multi-scale aggregator 220 is included in the text encoder, and multi-scale aggregator 220 includes a text multi-scale aggregator in an image encoder. In some cases, the text encoder is the pre-trained encoder. In some cases, multimodal encoder 215 includes the image encoder and the text encoder. In some cases, adapter 225 is implemented in the image encoder.

According to some aspects, multimodal encoder 215 comprises parameters stored in at least one memory of memory unit 210. Multimodal encoder 215 is an example of, or includes aspects of, the corresponding element described with reference to FIGS. 3-4. According to some aspects, multimodal encoder 215 is implemented as one or more hardware circuits, as firmware, as software stored in memory of memory unit 210 and executed by a processor of processor unit 205, or as a combination thereof. In some cases, multimodal encoder 215 is implemented as parameters stored in memory unit 210.

According to some aspects, response component 230 generates a response to the prompt based on the prompt embedding. In some cases, response component 230 generates the response by retrieving data that corresponds to the prompt embedding and including the data in the response. In some cases, response component 230 generates the response by generating the data corresponding to the prompt embedding. For example, in some cases, response component 230 comprises a generative adversarial network (GAN) or a diffusion model configured to generate the response based on the prompt embedding.

According to some aspects, a GAN is an ANN in which two neural networks (e.g., a generator and a discriminator) are trained based on a contest with each other. For example, in some cases, the generator learns to generate a candidate by mapping information from a latent space to a data distribution of interest, while the discriminator distinguishes the candidate produced by the generator from a true data distribution of the data distribution of interest. In some cases, the training objective of the generator is to increase an error rate of the discriminator by producing novel candidates that the discriminator classifies as “real” (e.g., belonging to the true data distribution). Therefore, in some cases, given a training set, the GAN learns to generate new data with similar properties as the training set. GANs may be used in conjunction with supervised learning, semi-supervised learning, unsupervised learning, and reinforcement learning.

According to some aspects, a diffusion model learns a latent structure of a dataset by modeling a diffusion of data points from the dataset through latent space. In some cases, a diffusion model generates an output by removing noise from a noisy input according to a prediction of how the output should be represented.

According to some aspects, response component 230 is implemented as one or more hardware circuits, as firmware, as software stored in memory of memory unit 210 and executed by a processor of processor unit 205, or as a combination thereof. In some cases, multimodal encoder 215 is implemented as parameters stored in memory unit 210.

According to some aspects, training component 235 obtains training data including an image and text describing the image. In some examples, training component 235 trains the multimodal encoder based on the predicted image embedding and the predicted text embedding.

In some examples, training component 235 obtains a pre-trained encoder. In some examples, training component 235 inserts the image multi-scale aggregator and the text multi-scale aggregator into the pre-trained encoder to obtain multimodal encoder 215. In some aspects, the pre-trained encoder is trained using pre-training data in a first domain and the training data is in a second domain different from the first domain. In some examples, training component 235 inserts a text adapter following the text multi-scale aggregator into the pre-trained encoder. In some examples, training component 235 inserts an image adapter following the image multi-scale aggregator into the pre-trained encoder.

In some examples, training component 235 updates parameters of the text adapter, where multimodal encoder 215 is trained based on the updated parameters of the text adapter. In some examples, training component 235 updates parameters of the image adapter, where multimodal encoder 215 is trained based on the updated parameters of the image adapter.

FIG. 3 shows an example of a multimodal encoder 300 according to aspects of the present disclosure. Multimodal encoder 300 is an example of, or includes aspects of, the corresponding element described with reference to FIG. 2.

In one aspect, multimodal encoder 300 includes image encoder 305 and text encoder 320. In some cases, each of image encoder 305 and text encoder 320 are an encoder network of a multimodal encoder as described with reference to FIG. 2.

In one aspect, image encoder 305 includes image multi-scale aggregator 310 and image adapter 315. In some cases, image multi-scale aggregator 310 is implemented as a multi-scale aggregator as described with reference to FIG. 4. In some cases, image adapter 315 is implemented as an adapter described with reference to FIG. 4.

In one aspect, text encoder 320 includes text multi-scale aggregator 325 and text adapter 330. In some cases, text multi-scale aggregator 325 is implemented as a multi-scale aggregator as described with reference to FIG. 4. In some cases, text adapter 330 is implemented as an adapter described with reference to FIG. 4.

FIG. 4 shows an example of data flow in a multimodal encoder 400 according to aspects of the present disclosure. Multimodal encoder 400 is an example of, or includes aspects of, the corresponding element described with reference to FIGS. 2 and 3.

In one aspect, multimodal encoder 400 includes prompt 405, multi-head attention module 410, multi-head attention output 415, large-scale mask 420, large-scale output 425, middle-scale mask 430, middle-scale output 435, small-scale mask 440, small-scale output 445, multi-scale aggregator 450, aggregated output 455, first skip connection 460, first layer normalization layer 465, feed-forward network 470, adapter 475, second skip connection 480, second layer normalization layer 485, and prompt embedding 490.

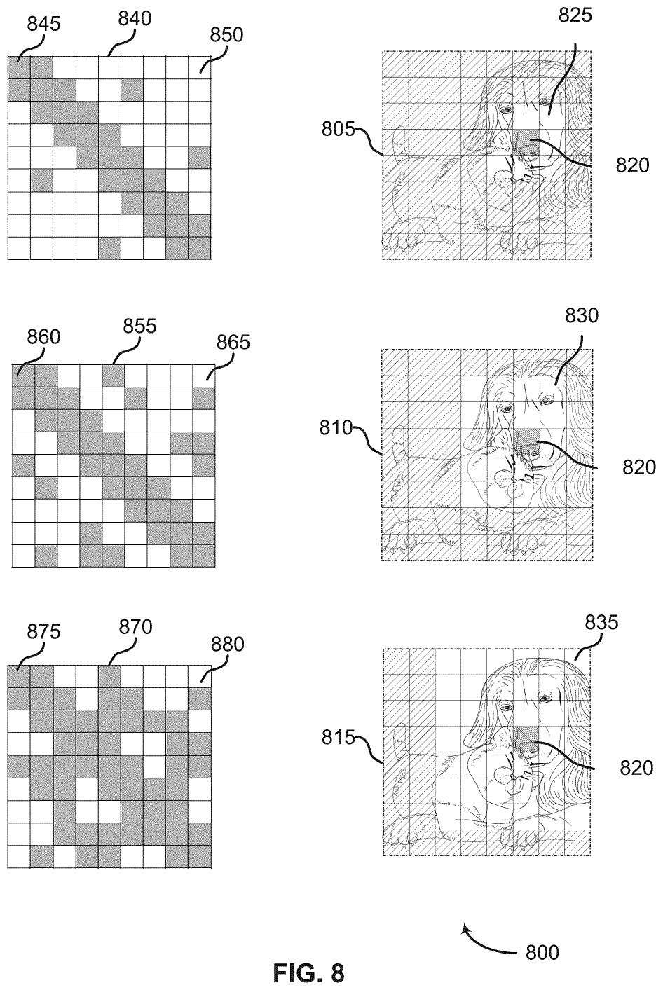

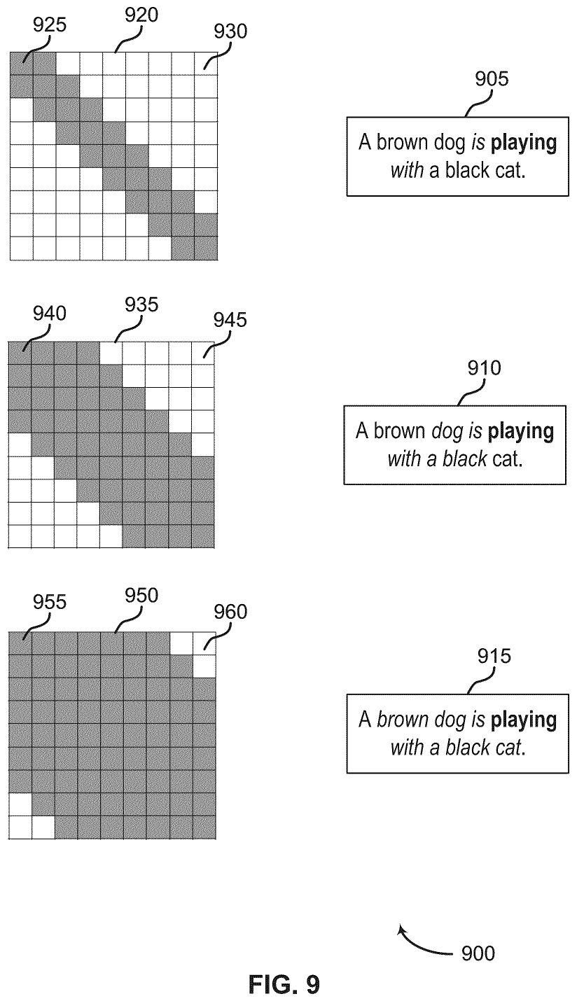

Prompt 405 is an example of, or includes aspects of, the corresponding element described with reference to FIGS. 5-6 and 10. Large-scale mask 420, middle-scale mask 430, and small-scale mask 440 are examples of, or include aspects of, the corresponding elements respectively described with reference to FIGS. 8-9.

Multi-head attention module 410 is an example of, or includes aspects of, the corresponding element described with reference to FIG. 2. Multi-scale aggregator 450 is an example of, or includes aspects of, the corresponding elements described with reference to FIGS. 2 and 3. Adapter 475 is an example of, or includes aspects of, the corresponding elements described with reference to FIGS. 2 and 3.

Referring to FIG. 4, multi-head attention module 410 receives prompt 405 (for example, from a user device such as the user device described with reference to FIG. 1). Multi-head attention module 410 generates multi-head attention output 415 (for example, a feature vector) based on prompt 405. In some cases, multimodal encoder 400 or a machine learning apparatus (such as the machine learning apparatus described with reference to FIGS. 1 and 2) applies large-scale mask 420, middle-scale mask 430, and small-scale mask 440 to multi-head attention output 415 to respectively obtain large-scale output 425, middle-scale output 435, and small-scale output 445 (e.g., a set of feature vectors at multiple attention scales including different amounts of information). In some cases, a dimension of one or more of large-scale output 425, middle-scale output 435, and small-scale output 445 is different than a dimension of multi-head attention output 415.

In some cases, multi-scale aggregator 450 combines large-scale output 425, middle-scale output 435, and small-scale output 445 to obtain aggregated output 455 (e.g., a feature vector comprising an aggregation of the set of feature vectors at multiple attention scales). In some cases, a dimension of aggregated output 455 is a same dimension as the dimension of multi-head attention output 415.

In some cases, first layer normalization layer 465 receives aggregated output 455. In some cases, first layer normalization layer 465 also receives multi-head attention output 415 via first skip connection 460. In some cases, first layer normalization layer 465 generates an output based on aggregated output 455 or on both aggregated output 455 and multi-head attention output 415. In some cases, feed-forward network 470 generates an output based on the output of first layer normalization layer 465. In some cases, adapter 475 generates an output based on the output of feed-forward network 470.

In some cases, second layer normalization layer 485 receives the output of adapter 475. In some cases, second layer normalization layer 485 receives the output of first layer normalization layer 465 via second skip connection 480. In some cases, adapter 475 and second skip connection 480 are omitted, and second layer normalization layer 485 receives the output of feed-forward network 470.

In some cases, second layer normalization layer 485 generates an output based on the output of adapter 475, the output of first layer normalization layer 465, the output of feed-forward network 470, or a combination thereof. In some cases, multimodal encoder 400 generates prompt embedding 490 based on the output of second layer normalization layer 485. In some cases, prompt embedding 490 is in a multimodal embedding space.

In some cases, an effect of an ensemble strategy or process described herein increases in the direction of the flow of data shown by FIG. 4.

### Multimodal Machine Learning

A method for multimodal machine learning is described with reference to FIGS. 5-10. One or more aspects of the method include obtaining a prompt; encoding the prompt using a multimodal encoder to obtain a prompt embedding, wherein the encoding comprises generating a plurality of multi-head attention (MHA) outputs corresponding to a plurality of different scales, respectively, and combining the plurality of MHA outputs using a multi-scale aggregator; and generating a response to the prompt based on the prompt embedding.

In some aspects, the prompt comprises a text prompt and the prompt embedding comprises a text embedding in a multimodal embedding space. In some aspects, the prompt comprises an image prompt and the prompt embedding comprises an image embedding in a multimodal embedding space.

Some examples of the method further include identifying a plurality of masks corresponding to the plurality of different scales, respectively, wherein the plurality of MHA outputs are based on the plurality of masks. In some aspects, each of the plurality of masks indicates neighboring pixels around a central pixel. In some aspects, each of the plurality of masks indicates neighboring words around a central word.

Some examples of the method further include processing an output of the multi-scale aggregator using an adapter, wherein the prompt embedding is based on an output of the adapter. In some aspects, the multimodal encoder comprises a pre-trained encoder that is fine-tuned based on the multi-scale aggregator.

FIG. 5 shows an example of a method 500 for cross-modal retrieval according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 5, an embodiment of the present disclosure is used in a cross-modal retrieval context. For example, a user (such as the user described with reference to FIG. 1) provides a text prompt (e.g., “A kitten sitting in a sink with a green brush with green bristles”) to the system (e.g., the machine learning system described with reference to FIG. 1). In some cases, the system generates an embedding for the text prompt using a machine learning model including a multimodal encoder (such as the multimodal encoder described with reference to FIGS. 2-4). In some cases, the system generates the embedding for the text prompt using an ensemble strategy of applying differently sized masks of an output of a multi-head attention module of the multimodal encoder to generate different outputs at different scales and then aggregating the different outputs. In some cases, by using the ensemble strategy, the system effectively increases a capacity of the multimodal encoder, allowing the multimodal encoder to generate a more accurate embedding for the text prompt than conventional machine learning systems.

In some cases, the system then retrieves an image embedding (for example, from a database such as the database described with reference to FIG. 1) and determines that the embedding for the text prompt matches the image embedding. Based on the determination, the system retrieves an image that corresponds to the image embedding (for example, from the database). In some cases, the system generates an image using the embedding of the text prompt as a guidance prompt (for example, using a diffusion model or a GAN). In some cases, the system generates a response including the image. In some cases, the system provides the response including the image to the user. Referring to FIG. 5, the image depicts content described by the text prompt.

At operation 505, the user provides a prompt. In some cases, the operations of this step refer to, or may be performed by, a user as described with reference to FIG. 1. For example, in some cases, the user provides a prompt (e.g., a text prompt, an image prompt, or a prompt in another modality) to a machine learning apparatus of the system via a user device (such as the machine learning apparatus and the user device described with reference to FIG. 1). In some cases, a user interface provided by the system on the user device facilitates the transmission of the prompt from the user to the user device and from the user device to the machine learning apparatus.

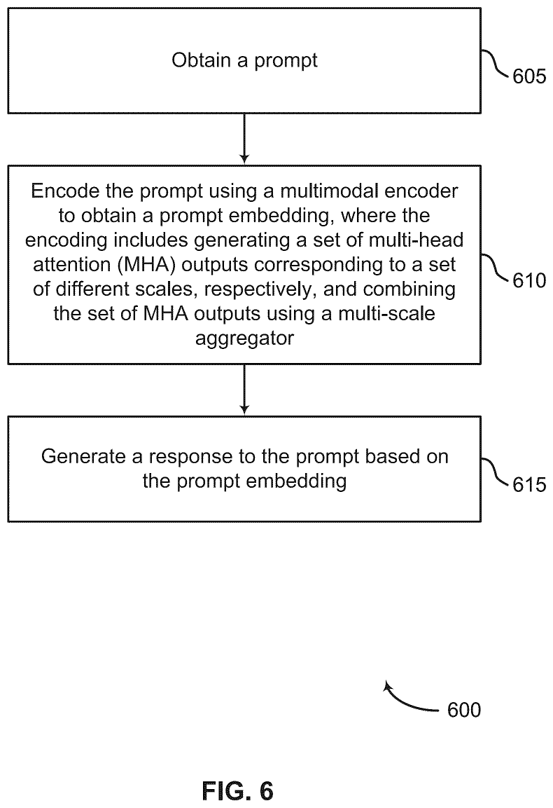

At operation 510, the system encodes the prompt to obtain a prompt embedding. In some cases, the operations of this step refer to, or may be performed by, a machine learning apparatus as described with reference to FIGS. 2-4. For example, in some cases, the machine learning apparatus obtains the prompt embedding using a multimodal encoder as described with reference to FIG. 6.

At operation 515, the system provides a response based on the prompt embedding. In some cases, the operations of this step refer to, or may be performed by, a machine learning apparatus as described with reference to FIGS. 2-4. For example, in some cases, the machine learning apparatus transmits the response to the user device. In some cases, the user device provides the response to the user via the user interface of the user device provided by the machine learning apparatus.

FIG. 6 shows an example of a method 600 for generating a response to a prompt according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 6, an embodiment of the present disclosure provides a machine learning model including an augmented capacity using an ensemble strategy. In general, an ensemble strategy benefits machine learning algorithms by making the machine learning algorithms more powerful as a whole. In particular, in some cases, an embodiment of the present disclosure employs an ensemble strategy by generating an output for an input prompt using a multimodal encoder, then generating multiple outputs at multiple scales based on the output to provide a diverse representation of the input, then aggregating the multiple outputs, and finally generating an embedding based on the multiple outputs using the multimodal encoder.

Accordingly, in some cases, by generating an embedding for the input based on the aggregated outputs, a capacity of the multimodal encoder is effectively increased without greatly increasing a number of parameters of the multimodal encoder. In some cases, the effectively increased capacity of the multimodal encoder allows the multimodal encoder to generate a more accurate embedding for the input than conventional machine learning systems are capable of providing without retraining a conventional multimodal encoder, which is a resource-intensive and time-consuming process. The more accurate embedding produced by the multimodal encoder allows the machine learning system to use the embedding to generate a response that accurately corresponds to the input prompt.

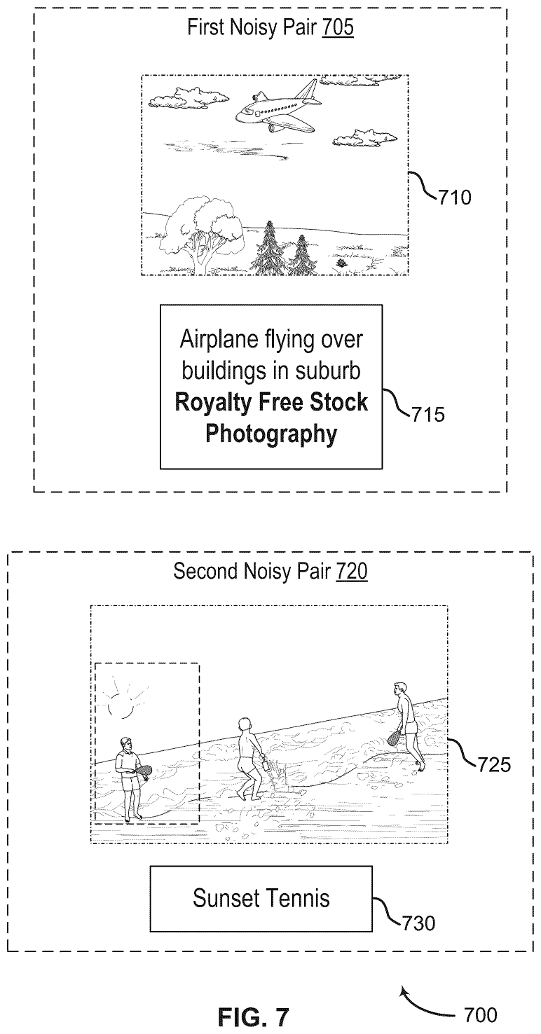

Furthermore, in some cases, the multimodal encoder comprises a pre-trained encoder. In some cases, the effectively increased capacity of the machine learning model allows the multimodal encoder to compensate for noisy training data that might influence the pre-trained encoder to make incorrect predictions for a given input. An example of noisy training data is provided with reference to FIG. 7.

At operation 605, the system obtains a prompt. In some cases, the operations of this step refer to, or may be performed by, a machine learning apparatus as described with reference to FIGS. 1 and 2.

For example, in some cases, a user provides the prompt to the machine learning apparatus. In some cases, the machine learning apparatus retrieves the prompt from a data source (e.g., a database, such as the database described with reference to FIG. 1). In some cases, the prompt comprises a text prompt. In some cases, the prompt comprises an image prompt. In some cases, the prompt comprises content in a modality other than a text modality or an image modality (e.g., an audio modality or a video modality).

At operation 610, the system encodes the prompt using a multimodal encoder to obtain a prompt embedding, where the encoding includes generating a set of multi-head attention (MHA) outputs corresponding to a set of different scales, respectively, and combining the set of MHA outputs using a multi-scale aggregator. In some cases, the operations of this step refer to, or may be performed by, a multimodal encoder as described with reference to FIGS. 2 and 3.

For example, in some cases, an MHA module of the multimodal encoder generates a feature vector f based on the prompt using a self-attention block, where an attention score matrix for the feature vector f is given by:

$$Att ( Q , K , V ) = softmax ( \frac{{QK}^{T}}{\sqrt{{d}_{k}}} ) V \qquad ( 1 )$$

In some cases, Q, K, and V are respectively, query, key, and value vectors after projections, and dₖ is a feature dimension of K.

In some cases, the machine learning apparatus or the multimodal encoder generates the set of MHA outputs by identifying a corresponding set of masks and applying the corresponding set of masks to the attention score matrix for the feature vector f output by the MHA module. In some cases, the set of masks includes a large-scale mask, a middle-scale mask, and a small-scale mask, and the set of MHA outputs correspondingly includes a large-scale output, a middle-scale output, and a small-scale output. In some cases, the machine learning system separates the original attention corresponding to the feature vector f into the set of different scales by applying the set of masks.

In some cases, the prompt is a text prompt, and each mask of the set of masks is given by:

$${M}_{C}^{*} [ i , j ] = \{ \begin{matrix}1 , & \vert i - j \vert < {D}_{C}^{*} \\ 0 , & \vert i - j \vert \geq {D}_{C}^{*}\end{matrix} \qquad ( 2 )$$

In some cases, M*_{C}∈ [symbol] ^{T}^{_{C}}^{×T}^{_{C}}, where T_{C} is a number of caption tokens for the multimodal encoder, and D*_{C} is a length of scale *, where *∈{L, M, S} for a large scale, a middle scale, and a small scale, respectively. In some cases, the large scale includes more caption tokens than the middle scale, and the middle scale includes more caption tokens than a small scale. In some cases, the output of the MHA module for the text prompt is a one-dimensional sequence, and each mask of the set of masks is a banded matrix. In some cases, each mask of the set of masks indicates neighboring words around a central word of the text prompt. An example of a set of masks applied to an output of the MHA module based on a text prompt is shown by FIG. 9.

Similarly, in some cases, the prompt is an image prompt, and each mask of the set of masks is given by:

$${M}_{I}^{*} [ i , j ] = \{ \begin{matrix}1 , & max ( \vert {x}_{i} - {x}_{j} \vert , \vert {y}_{i} - {y}_{j} \vert ) < {D}_{I}^{*} \\ 0 , & max ( \vert {x}_{i} - {x}_{j} \vert , \vert {y}_{i} - {y}_{j} \vert ) \geq {D}_{I}^{*}\end{matrix} \qquad ( 3 )$$

In some cases, x_{i,j} and y_{i,j} are two-dimensional visual patch positions converted from a one-dimensional token sequence given by xₖ=└k/P_{I}┘, yₖ =k−xₖ·P_{I}, where P_{I} is a number of patches in each row (or column) in a given image prompt. Accordingly, in some cases, the converting step converts the mask from a banded matrix to a matrix representing two dimensions. In some cases, each of the set of masks indicates neighboring pixels around a central pixel of the image prompt. In some cases, the large scale includes more pixel information than the middle scale, and the middle scale includes more pixel information than a small scale. An example of a set of masks applied to an output of the MHA module based on an image prompt is shown by FIG. 8.

In some cases, each output of the set of MHA outputs of different scales are therefore determined according to multi-scale attention based on the set of masks:

$${Att}^{*} ( Q , K , V ) = softmax ( \frac{{QK}^{T} ⊙ {M}^{*}}{\sqrt{{d}_{k}}} ) V \qquad ( 4 )$$

In some cases, ⊙ applies a mask M* of the set of masks to the attention score matrix. Accordingly, in some cases, the multimodal encoder outputs a set of MHA outputs f* (e.g., f^{L}, f^{M}, f^{S}) based on the feature vector f.

In some cases, a multi-scale aggregator (such as the multi-scale aggregator described with reference to FIGS. 2-4) combines (e.g., aggregates) the set of MHA outputs f* by projecting each MHA output of the set of MHA outputs f* to a same dimensionality of the feature vector f using an ensemble process:

$${f}^{ens} = ⌊ {f}^{L} , {f}^{M} , {f}^{S} ⌋ {W}^{ens} \qquad ( 5 )$$

In some cases, W^{ens} is a pyramid projection of the set of MHA outputs f*.

In some cases, the aggregated output includes the feature vector f (for example, via a skip connection described with reference to FIG. 4):

$${f}^{ens} = f + ⌊ {f}^{L} , {f}^{M} , {f}^{S} ⌋ {W}^{ens} \qquad ( 6 )$$

In some cases, therefore, given the feature vector f∈ [symbol] ^{d} and the set of MHA outputs, the multi-scale aggregator projects the feature vector f∈ [symbol] ^{d} and the set of MHA outputs using a pyramid layer given by:

$${f}^{ens} = f + ( {\overbrace{\vert f , … f \vert}}^{N} ) {W}^{ens} \qquad ( 7 )$$

In some cases, W^{ens}∈ [symbol] ^{Nd×d}. In some cases, a bias term is omitted from Equation 7 for convenience. In some cases, N is a number of MHA outputs in the set of MHA outputs (e.g., a number of copies of feature vector f at different scales to be concatenated). Therefore, in some cases, each d-dimensional sub-matrix in W^{ens} can be treated as a basic learner and the pyramid projection of the multi-scale aggregator is an ensemble module.

In some cases, the multi-scale aggregator therefore takes advantage of the diverse representations of the prompt provided by the set of MHA outputs to achieve a crowd intelligence for performance boosting. In some cases, the ensemble can be viewed as a weighting strategy or a voting strategy.

In some cases, the multi-scale aggregator directly receives the feature vector f∈ [symbol] ^{d} and the set of MHA outputs from the MHA module. In some cases, a feed-forward network of the multimodal encoder processes the feature vector f∈ [symbol] ^{d} and the set of MHA outputs and the multi-scale aggregator generates the aggregated output based on the output of the feed-forward network. In some cases, the multi-scale aggregator both directly receives the feature vector f∈ [symbol] ^{d} and the set of MHA outputs from the MHA module and receives the processed output of the feed-forward network (e.g., the processed feature vector f∈ [symbol] ^{d} and the processed set of MHA outputs) via a skip-connection, and generates the aggregated output based on both the output of the MHA module and the output of the feed-forward network.

In some cases, the multimodal encoder comprises a pre-trained encoder (e.g., a CLIP model) that is fine-tuned based on the multi-scale aggregator. For example, in some cases, parameters of the multi-scale aggregator are fine-tuned as described with reference to FIG. 11. In some cases, the multimodal encoder generates the prompt embedding based on the aggregated output.

In some cases, the machine learning apparatus processes the aggregated output using an adapter (e.g., an adapter as described with reference to FIGS. 2-4), where the prompt embedding is based on an output of the adapter. For example, in some cases, the multimodal encoder generates the prompt embedding based on an output of the adapter as described with reference to FIG. 4. In some cases, the adapter further increases the capacity of the multimodal encoder, thereby increasing an accuracy of the prompt embedding.

In some cases, a total number of additional learnable parameters can be calculated. In some cases, given L blocks in the multimodal encoder, a total number of additional learnable parameters is given by L×Nd×d, where d×d is an adapter unit of the adapter and L×N is the total number of adapter units.

In some cases, the adapter is implemented as a bottleneck, for example, two bottlenecks respectively inserted after a self-attention layer and a feed-forward network of the multimodal encoder connected by a skip connection:

$${f}^{bo} = f + F ( ( f \cdot {W}^{1} ) {W}^{2} , ( f \cdot {W}^{3} ) {W}^{4} ) \qquad ( 8 )$$

In some cases, W¹, W³∈ [symbol] ^{d×d}^{ₐ} and W², W⁴∈ [symbol] ^{d}^{ₐ}^{×d}, where dₐ is a hidden dimension and F(⋅,⋅) serves as an ensemble operation (for example, implemented as averaging).

Accordingly, in some cases, the machine learning system uses masks for different scales to extract features from a prompt using a pre-trained (in some cases, frozen) encoder (such as CLIP) to provide diverse representations benefiting an ensemble process that is achieved via pyramid projection provided by the multi-scale aggregator.

In some cases, the pre-trained encoder is fine-tuned based on the adapter. For example, in some cases, parameters of the adapter are fine-tuned as described with reference to FIG. 11.

In some cases, the prompt embedding comprises a text embedding in a multimodal embedding space. In some cases, the prompt embedding comprises an image embedding in the multimodal embedding space. As used herein, a “multimodal embedding space” refers to a relatively low-dimensional space into which high-dimensional vectors can be translated.

At operation 615, the system generates a response to the prompt based on the prompt embedding. In some cases, the operations of this step refer to, or may be performed by, a response component as described with reference to FIG. 2.

In some cases, the multimodal embedding space allows semantic information captured by the prompt embedding to be compared to another embedding in the multimodal embedding space based on a distance between the joint embedding and the other embedding. Therefore, in some cases, the multimodal embedding space allows the machine learning system to determine semantically similar information that originates in a same or different modalities.

In some cases, the response component retrieves another embedding from a data source (such as the database as described with reference to FIG. 1). In some cases, the other embedding is in the multimodal embedding space. In some cases, the response component compares the prompt embedding to the other embedding using a similarity metric such as a cosine similarity or a Euclidean distance. In some cases, if the response component determines that the prompt embedding is sufficiently similar to the other embedding based on the similarity metric (for example, if the cosine similarity exceeds a similarity threshold or if the Euclidean distance is less than a similarity threshold), the response component determines that the other embedding matches the prompt embedding.

In some cases, the response component retrieves data corresponding to the other embedding (for example, a text or an image) in response to the determination that the prompt embedding matches the other embedding. In some cases, the user can select a modality for the retrieved data (for example, via the user interface displayed on the user device). In some cases, the response component generates the response by including the retrieved data in the response.

In some cases, the response component generates data based on the prompt embedding using one or more ANNs such as a GAN or a diffusion model. In some cases, the user can select a modality for the generated data (for example, via the user interface displayed on the user device). In some cases, the response component generates the response by including the generated data in the response.

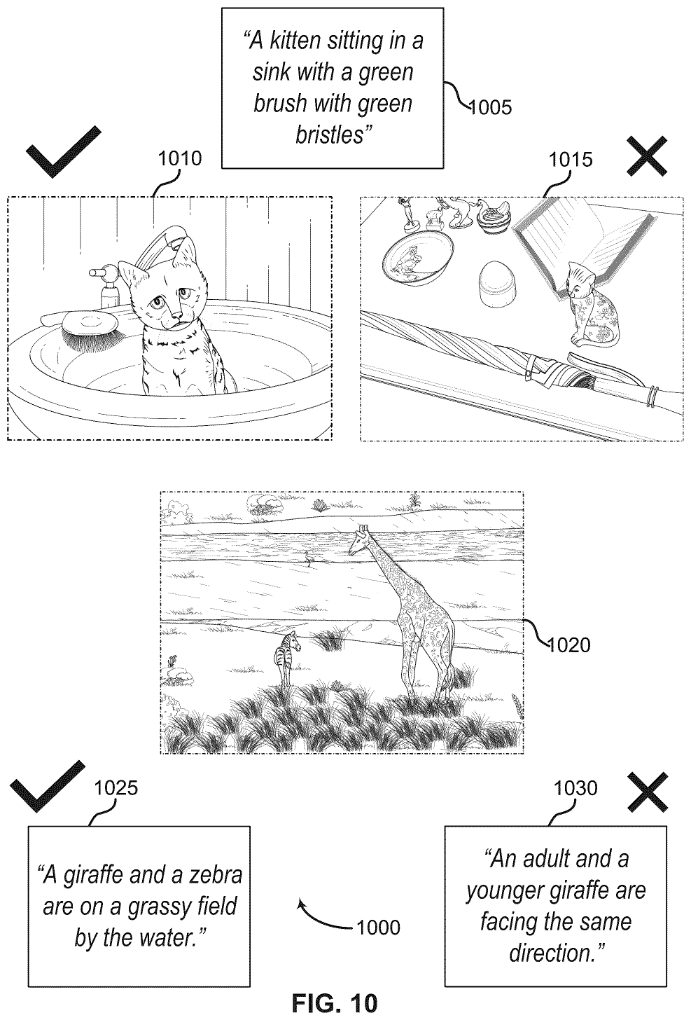

In some cases, the machine learning system provides the response to the user (for example, by transmitting the response to the user device and displaying the response via the user interface of the user device). An example of responses generated by the machine learning system in a cross-modal retrieval context and comparative responses generated by a comparative machine learning system are described with reference to FIG. 10.

FIG. 7 shows an example of noisy paired samples 700 according to aspects of the present disclosure. In one aspect, noisy paired samples 700 includes first noisy pair 705 and second noisy pair 720. In one aspect, first noisy pair 705 includes first image 710 and first caption 715. In one aspect, second noisy pair 720 includes second image 725 and second caption 730.

Referring to FIG. 7, in some cases, a training pair included in a training dataset for a multimodal encoder may be noisy due to a mismatch between components of the training pair. For example, first noisy pair 705 is noisy because first caption 715 includes bolded words “Royalty Free Stock Photography” that do not describe the content of first image 710. Such a cross-modal misalignment between a caption and an image can mislead a multimodal encoder that is trained on first noisy pair 705. In some cases, the different scales of the set of MHA outputs described with reference to FIG. 6 help to reduce such misaligned noise to promote more fine-grained contrastive learning.

Second noisy pair 720 is noisy because second caption 730 only describes the content of the bounding box shown for second image 725, and not the content of the entirety of second image 725. The mismatch by omission shown by second noisy pair 720 can also mislead a multimodal encoder that is trained on second noisy pair 720.

FIG. 8 shows an example of a multi-scale image attention process 800 according to aspects of the present disclosure. The example shown first image representation 805, second image representation 810, third image representation 815, small-scale image mask 840, middle-scale image mask 855, and large-scale image mask 870.

In one aspect, first image representation 805 includes central pixel 820 and first neighboring pixels 825. In one aspect, second image representation 810 includes central pixel 820 and second neighboring pixels 830. In one aspect, third image representation 815 includes central pixel 820 and third neighboring pixels 835.

In one aspect, small-scale image mask 840 includes first unmasked image region 845 and first masked image region 850. In one aspect, middle-scale image mask 855 includes second unmasked image region 860 and second masked image region 865. In one aspect, large-scale image mask 870 includes third unmasked image region 875 and third masked image region 880.

Referring to FIG. 8, first image representation 805 is a visual representation of small-scale image mask 840 applied to a feature vector f generated based on an image prompt. Each of first image representation 805, second image representation 810, and third image representation 815 include a representation of a total number of pixels corresponding to the total number of pixels of the image prompt. First image representation 805 shows that by applying first unmasked image region 845 and first masked image region 850 of small-scale image mask 840 to the feature vector, a small-scale feature vector f^{S} is generated that includes information corresponding only to central pixel 820 and first neighboring pixels 825 (shown as the full-color region of first image representation 805) instead of information corresponding to each pixel of the image prompt (as represented by the feature vector f).

Likewise, as respectively shown by the successively larger areas of second neighboring pixels 830 and third neighboring pixels 835 of second image representation 810 and third image representation 815, by applying middle-scale image mask 855 and large-scale image mask 870 to the feature vector f generated based on the image prompt, a middle-scale feature vector f^{M} and a large-scale feature vector f^{L} are generated including respectively greater amounts of information than small-scale feature vector f^{S}.

FIG. 9 shows an example of a multi-scale text attention process 900 according to aspects of the present disclosure. The example shown includes first text representation 905, second text representation 910, third text representation 915, small-scale mask 920, first unmasked region 925, first masked region 930, middle-scale mask 935, second unmasked region 940, second masked region 945, large-scale mask 950, third unmasked region 955, and third masked region 960.

Referring to FIG. 9, first text representation 905 is a visual representation of small-scale mask 920 applied to a feature vector f generated based on a text prompt. Each of first text representation 905, second text representation 910, and third text representation 915 include a representation of each word included in a text prompt “A brown dog is playing with a black cat”, where a central word “playing” is indicated by bolding. First text representation 905 shows that by applying first unmasked region 925 and first masked region 930 of small-scale mask 920 to the feature vector, a small-scale feature vector f^{S} is generated that includes information corresponding only to the central word and neighboring words (shown as the italicized words of first text representation 905) instead of information corresponding to each word of the text prompt (as represented by the feature vector f).

Likewise, as respectively shown by the successively greater number of italicized words of second text representation 910 and third text representation 915, by applying middle-scale mask 935 and large-scale mask 950 to the feature vector f generated based on the text prompt, a middle-scale feature vector f^{M} and a large-scale feature vector f^{L} are generated including respectively greater amounts of information.

FIG. 10 shows an example of cross-modal retrieval results 1000 according to aspects of the present disclosure. The example shown includes text prompt 1005, first response 1010, first comparative response 1015, image prompt 1020, second response 1025, and second comparative response 1030.

Referring to FIG. 10, first response 1010 is an example of a response including an image that is provided by the machine learning system in response to text prompt 1005, and first comparative response 1015 is an example of a response provided by a comparative machine learning system in response to text prompt 1005. In some cases, each of the machine learning system and the conventional machine learning system can use a pre-trained encoder to generate an initial feature vector based on the text prompt. However, comparing first response 1010 and first comparative response 1015, first response 1010 more closely matches the content of text prompt 1005 than comparative first response 1015 does. In some cases, first response 1010 more closely matches text prompt 1005 than comparative first response 1015 does because the machine learning system generates a more accurate prompt embedding of text prompt 1005 based on the output of the multi-scale aggregator as described with reference to FIG. 6.

Likewise, second response 1025 is an example of a response including a text description of an image that is provided by the machine learning system in response to image prompt 1020, and second comparative response 1030 is an example of a response provided by a comparative machine learning system in response to image prompt 1020. Comparing second response 1025 and second comparative response 1030, second response 1025 more closely matches the content of image prompt 1020 than comparative second response 1030 does. In some cases, second response 1025 more closely matches image prompt 1020 than comparative second response 1030 does because the machine learning system generates a more accurate prompt embedding of image prompt 1020 based on the output of the multi-scale aggregator as described with reference to FIG. 6

### Training

A method for multimodal machine learning is described with reference to FIG. 11. One or more aspects of the method include obtaining training data comprising an image and text describing the image; encoding the text using a multimodal encoder to obtain a predicted text embedding, wherein encoding the text comprises generating a plurality of multi-head attention (MHA) text outputs corresponding to a plurality of different text scales, respectively, and combining the plurality of MHA text outputs using a text multi-scale aggregator; encoding the image using the multimodal encoder to obtain a predicted image embedding, wherein encoding the image comprises generating a plurality of MHA image outputs corresponding to a plurality of different image scales, respectively, and combining the plurality of MHA image outputs using an image multi-scale aggregator; and training the multimodal encoder based on the predicted image embedding and the predicted text embedding.

Some examples of the method further include obtaining a pre-trained encoder. Some examples further include inserting the image multi-scale aggregator and the text multi-scale aggregator to obtain the multimodal encoder. In some aspects, the pre-trained encoder is trained using pre-training data in a first domain and the training data is in a second domain different from the first domain.

Some examples of the method further include inserting a text adapter following the text multi-scale aggregator. Some examples further include inserting an image adapter following the image multi-scale aggregator. Some examples of the method further include updating parameters of the text adapter, wherein the multimodal encoder is trained based on the updated parameters of the text adapter. Some examples of the method further include updating parameters of the image adapter, wherein the multimodal encoder is trained based on the updated parameters of the image adapter.

FIG. 11 shows an example of a method 1100 for training a multimodal encoder according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 11, in some cases, a multimodal encoder (such as the multimodal encoder described with reference to FIGS. 2-4) is trained based on a predicted image embedding and a predicted text embedding. In some cases, the multimodal encoder is trained based on updated parameters of an adapter (such as the adapter described with reference to FIGS. 2-4). In some cases, by updating parameters of the adapter, the system avoids re-training a pre-trained encoder included in the multimodal encoder, which is a computationally expensive and time-consuming process.

At operation 1105, the system obtains training data including an image and text describing the image. In some cases, the operations of this step refer to, or may be performed by, a training component as described with reference to FIG. 2.

In some cases, the training component obtains the training data from a database (such as the database described with reference to FIG. 1). In some cases, the training component obtains the training data in response to a user command.

At operation 1110, the system encodes the text using a multimodal encoder to obtain a predicted text embedding, where encoding the text includes generating a set of multi-head attention (MHA) text outputs corresponding to a set of different text scales, respectively, and combining the set of MHA text outputs using a text multi-scale aggregator. In some cases, the operations of this step refer to, or may be performed by, a multimodal encoder as described with reference to FIGS. 2 and 3.

For example, in some cases, the predicted text embedding is similar to the text embedding described with reference to FIG. 6, and the multimodal encoder obtains the predicted text embedding using the multi-scale aggregator in a similar manner as the text embedding is obtained using the multi-scale aggregator as described with reference to FIG. 6.

In some cases, the training component obtains a pre-trained encoder (for example, the pre-trained encoder described with reference to FIG. 2). In some cases, the pre-trained encoder is a CLIP model. In some cases, the pre-trained encoder is trained using pretraining data in a first domain and the training data is in a second domain different from the first domain.

In some cases, the training component obtains the multimodal encoder by inserting an image multi-scale aggregator (such as the image multi-scale aggregator described with reference to FIGS. 2-4) and a text multi-scale aggregator (such as the text multi-scale aggregator described with reference to FIGS. 2-4) into the pre-trained encoder.

In some cases, the training component inserts a text adapter (such as the text adapter described with reference to FIGS. 2-4) into the pre-trained encoder to obtain the multimodal encoder. In some cases, the text adapter is implemented as a reverse-bottleneck structure on top of a text encoder of the multimodal encoder that includes the pre-trained encoder and the text multi-scale aggregator.

In some cases, the training component inserts an image adapter (such as the image adapter described with reference to FIGS. 2-4) into the pre-trained encoder to obtain the multimodal encoder. In some cases, the image adapter is implemented as a reverse-bottleneck structure on top of an image encoder of the multimodal encoder that includes the pre-trained encoder and the image multi-scale aggregator.

At operation 1115, the system encodes the image using the multimodal encoder to obtain a predicted image embedding, where encoding the image includes generating a set of MHA image outputs corresponding to a set of different image scales, respectively, and combining the set of MHA image outputs using an image multi-scale aggregator. In some cases, the operations of this step refer to, or may be performed by, a multimodal encoder as described with reference to FIGS. 2 and 3.

For example, in some cases, the predicted image embedding is similar to the image embedding described with reference to FIG. 6, and the multimodal encoder obtains the predicted image embedding using the multi-scale aggregator in a similar manner as the image embedding is obtained using the multi-scale aggregator as described with reference to FIG. 6.

At operation 1120, the system trains the multimodal encoder based on the predicted image embedding and the predicted text embedding. In some cases, the operations of this step refer to, or may be performed by, a training component as described with reference to FIG. 2.

For example, in some cases, the training component determines a loss (such as a contrastive loss) using a loss function (such as a contrastive loss function). A loss function refers to a function that impacts how a machine learning model is trained in a supervised learning model. Specifically, during each training iteration, the output of the model is compared to the known annotation information in the training data. The loss function provides a value (a “loss”) for how close the predicted annotation data is to the actual annotation data. After computing the loss, the parameters of the model are updated accordingly and a new set of predictions are made during the next iteration.

Contrastive learning refers to a type of machine learning in which a model is trained using the selection of positive and negative sample pairs. Contrastive learning can be used in either a supervised or an unsupervised (e.g., self-supervised) training context. A loss function for a contrastive learning model can encourage a model to generate similar results for positive sample pairs, and dissimilar results for negative sample pairs.

Supervised learning is one of three basic machine learning paradigms, alongside unsupervised learning and reinforcement learning. Supervised learning is a machine learning technique based on learning a function that maps an input to an output based on example input-output pairs. Supervised learning generates a function for predicting labeled data based on labeled training data consisting of a set of training examples. In some cases, each example is a pair consisting of an input object (typically a vector) and a desired output value (i.e., a single value, or an output vector). A supervised learning algorithm analyzes the training data and produces the inferred function, which can be used for mapping new examples. In some cases, the learning results in a function that correctly determines the class labels for unseen instances. In other words, the learning algorithm generalizes from the training data to unseen examples.

Accordingly, in some cases, the training component determines a loss by comparing the predicted image embedding and the predicted text embedding. In some cases, the training component compares the predicted image embedding and a second text embedding generated by the multimodal encoder for a second text that does not describe the image. In some cases, the training component compares the predicted text embedding and a second image embedding generated by the multimodal encoder for a second image that is not described by the text. In some cases, the training component determines the loss based on the comparison of the predicted image and the predicted text embedding, the predicted image embedding and the second text embedding, the predicted text embedding and the second image embedding, or a combination thereof.

In some cases, the training component trains the multimodal encoder by updating the parameters of the multimodal encoder based on the loss (for example, via backpropagation). In some cases, the training component trains the multimodal encoder by freezing the weights of the pre-trained encoder and updating the parameters of the text multi-scale aggregator, the image multi-scale aggregator, the text adapter, the image adapter, or a combination thereof based on the loss (for example, via backpropagation). In some cases, by inserting the text adapter, the image adapter, or a combination thereof into the pre-trained encoder to obtain the multimodal encoder, and updating the parameters of the text adapter, the image adapter, or a combination thereof while freezing the pre-trained encoder, the machine learning system thereby provides an ability to train the multimodal encoder to use the multiscale aggregator, which increases the performance of the pre-trained encoder, while avoiding re-training the pre-trained encoder, which is an expensive and time-consuming process.

In some cases, the training component updates the parameters of the text adapter, the image adapter, or a combination thereof by fine-tuning the text adapter, the image adapter, or the combination thereof. In some cases, the training component uses a near-identity initialization when fine-tuning the text adapter, the image adapter, or the combination thereof. In some cases, the training component does not use a residual skip when fine-tuning the text adapter, the image adapter, or the combination thereof.

In some cases, each of the text adapter and the image adapter are implemented as parameters inserted into each transformer block of the pre-trained encoder. In some cases, each of the text adapter and the image adapter are implemented using a residual block, thereby integrating an ensemble factor. In some cases, the training component converts the reverse bottleneck structure to a series of projections sharing a same dimension with the residual block, thereby further integrating the ensemble factor. In some cases, each of the text adapter and the image adapter are inserted directly after a self-attention block and a hidden dimension in the multimodal encoder is adjusted to keep a number of overall learnable parameters the same as prior to the insertion of the text adapter and the image adapter.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also, the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for multimodal machine learning, comprising:
obtaining a prompt;
encoding the prompt using a multimodal encoder to obtain a prompt embedding, wherein the encoding comprises generating a plurality of multi-head attention (MHA) outputs corresponding to a plurality of different scales, respectively, and combining the plurality of MHA outputs using a multi-scale aggregator; and
generating a response to the prompt based on the prompt embedding.

2. The method of claim 1, wherein:
the prompt comprises a text prompt and the prompt embedding comprises a text embedding in a multimodal embedding space.

3. The method of claim 1, wherein:
the prompt comprises an image prompt and the prompt embedding comprises an image embedding in a multimodal embedding space.

4. The method of claim 1, further comprising:
identifying a plurality of masks corresponding to the plurality of different scales, respectively, wherein the plurality of MHA outputs are based on the plurality of masks.

5. The method of claim 4, wherein:
each of the plurality of masks indicates neighboring pixels around a central pixel.

6. The method of claim 4, wherein:
each of the plurality of masks indicates neighboring words around a central word.

7. The method of claim 1, further comprising:
processing an output of the multi-scale aggregator using an adapter, wherein the prompt embedding is based on an output of the adapter.

8. The method of claim 1, wherein:
the multimodal encoder comprises a pre-trained encoder that is fine-tuned based on the multi-scale aggregator.

9. A method for multimodal machine learning, comprising:
obtaining training data comprising an image and text describing the image;
encoding the text using a multimodal encoder to obtain a predicted text embedding, wherein encoding the text comprises generating a plurality of multi-head attention (MHA) text outputs corresponding to a plurality of different text scales, respectively, and combining the plurality of MHA text outputs using a text multi-scale aggregator;
encoding the image using the multimodal encoder to obtain a predicted image embedding, wherein encoding the image comprises generating a plurality of MHA image outputs corresponding to a plurality of different image scales, respectively, and combining the plurality of MHA image outputs using an image multi-scale aggregator; and
training the multimodal encoder based on the predicted image embedding and the predicted text embedding.

10. The method of claim 9, further comprising:
obtaining a pre-trained encoder; and
inserting the image multi-scale aggregator and the text multi-scale aggregator to obtain the multimodal encoder.

11. The method of claim 10, wherein:
the pre-trained encoder is trained using pre-training data in a first domain and the training data is in a second domain different from the first domain.

12. The method of claim 10, further comprising:
inserting a text adapter following the text multi-scale aggregator; and
inserting an image adapter following the image multi-scale aggregator.

13. The method of claim 12, further comprising:
updating parameters of the text adapter, wherein the multimodal encoder is trained based on the updated parameters of the text adapter.

14. The method of claim 12, further comprising:
updating parameters of the image adapter, wherein the multimodal encoder is trained based on the updated parameters of the image adapter.

15. An apparatus for multimodal machine learning, comprising:
at least one processor;
at least one memory storing instructions executable by the processor; and
the apparatus further comprising a multimodal encoder comprising parameters stored in the at least one memory, wherein the multimodal encoder comprises a multi-scale aggregator and is configured to encode a prompt to obtain a prompt embedding by generating a plurality of multi-head attention (MHA) outputs corresponding to a plurality of different scales, respectively, and combining the plurality of MHA outputs using the multi-scale aggregator.

16. The apparatus of claim 15, further comprising:
a training component configured to train the multimodal encoder.

17. The apparatus of claim 15, wherein:
the multimodal encoder comprises an image multi-scale aggregator in an image encoder and a text multi-scale aggregator in a text encoder.

18. The apparatus of claim 15, wherein:
the multimodal encoder comprises an adapter following the multi-scale aggregator.

19. The apparatus of claim 18, wherein:
the multimodal encoder is pretrained without the multi-scale aggregator and fine-tuned with the multi-scale aggregator.

20. The apparatus of claim 15, further comprising:
a response component configured to generate a response to the prompt based on the prompt embedding.
